(19) United States
(12) Patent Application Publication
(10) Pub. No.: US 2013/0182917 A1
(43) Pub. Date: Jul. 18, 2013

(54) DYNAMICALLY PRESENTING INFORMATION OF POTENTIAL INTEREST TO A VARYING TRANSITORY GROUP OF INDIVIDUALS SCANNED BY FACIAL RECOGNITION IN A CONSUMER MARKETING ENVIRONMENT

(71) Applicants: Barry Alan Kritt, Austin, TX (US); Sarbajit Kumar Rakshit, Kolkata (IN); Shawn Konrad Sremaniak, Austin, TX (US)

(72) Inventors: Barry Alan Kritt, Austin, TX (US); Sarbajit Kumar Rakshit, Kolkata (IN); Shawn Konrad Sremaniak, Austin, TX (US)

(73) Assignee: INTERNATIONAL BUSINESS MACHINES CORPORATION, Armonk, NY (US)

(21) Appl. No.: 13/351,190

(22) Filed: Jan. 16, 2012

(51) Int. Cl. G06K 9/00

(52) U.S. Cl. 382/118

(57) ABSTRACT

Video monitoring of groups of individuals who are passing into and out of defined areas, such as sections in shopping malls, to dynamically attempt to recognize and capture the profiles of a plurality of individuals who are in the defined area during a determined time period and whose facial recognition match stored facial recognition profiles. Accordingly, once the method recognizes the recognition profiles of a plurality of individuals, the plurality of recognized individuals have their interests screened for interests in common. These screened common interests may be used to directly present advertisements and like information in the area where the plurality of individuals have been recognized.

### TECHNICAL FIELD

The present invention relates to computer controlled facial recognition and particularly to the application of such recognition implementations in a real consumer marketing environment of goods and services, e.g. a shopping mall.

### BACKGROUND OF RELATED ART

The past generation has been marked by a technological evolution driven by the convergence of the data processing industry with the communications and consumer electronics industries. The effect has, in turn, driven technologies that have been known and available but relatively quiescent over the years to now come into the consumer related computer and communication industries marketplace. This is the situation with automated facial recognition applications. Facial recognition computer applications operate to automatically identify an individual person based upon a digital image of an individual stored in a database. The application operates by comparing a combination of the individual's facial features with the facial images stored in a database.

Facial recognition systems have been extensively used in government security systems to alert for potential criminals. However, the private commercial consumer marketplace has used facial recognition databases to catch shoplifters and like petty criminals in large stores with large areas and minimal employee coverage, such as supermarkets or giant discount stores.

Facial recognition applications identify faces by extracting features from an image of the subject's face. The algorithm used may relate the positions, sizes and shapes of the eyes, jaw, cheekbones and nose. These features and feature relationships are used to search for facial images in moving crowds for matches. There are currently two general approaches to facial recognition: Geometric, which looks at and relates distinguishing features; and Photometric, which is a statistical process wherein facial images are distilled into values that are compared to standard value templates.

### SUMMARY OF THE PRESENT INVENTION

In the past, the mass of facial recognition profiles in databases were of individuals involved or potentially involved in criminal activities. The present invention is the recognition where there is now a new generation of a mass of facial recognition profiles voluntarily submitted to the host and providers of the social media that provides present databases of great size that are expected to grow over the next few years at an accelerated pace. It is these newer databases that the present invention will use to determine the information to be presented based upon consumer interest.

Accordingly, the present invention video monitors groups of individuals who are passing into and out of defined areas, such as sections in shopping malls, to dynamically attempt to recognize and capture the profiles of a plurality of individuals who are in the defined area during a determined time period and whose facial recognition matches stored facial recognition profiles. The stored facial recognition profiles are in a database storing these profiles for a mass of individuals. This mass of individual profiles in the database may be developed from facial recognition profiles provided by individuals involved in the social media that promotes the submission of member profiles for social and commercial purposes. Because the facial recognition profiles are often derived from such profiles available from social media databases, such databases also store in association with the profiles a synopsis of many of the social, intellectual and consumer interests of each profiled individual.

Accordingly, once the method recognizes the recognition profiles of a plurality of individuals, the plurality of recognized individuals have their interest screened for common interests. These screened common interests may be used to directly present advertisements and like information in the area where the plurality of individuals have been recognized. The presented information may be in audio form, i.e. music. However, the invention is best served by audio-video presentations, large computer controlled displays in a shopping area, such as a shopping mall, to benefit local stores and businesses.

It should be recognized that the number of individuals sharing a common interest is a primary determinant of the value of an interest. There are additional factors in determining common interests. The determination may be weighted based upon a recognized significance of a given recognized individual to the commercial interests of the facility or portion of the facility where the facial recognition is set up.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a very generalized view of portions of an illustrative shopping mall illustrating how the pedestrian traffic is monitored by a bank of video cameras and the supporting systems for accessing local databases and remote databases via the Web or Internet storing the desired facial recognition profiles and interests of masses of individuals;

FIG. 2 is a block diagram of a data processing system including a central processing unit and network connections via a communications adapter that is capable of functioning as the user's computer controlled display stations and as Web servers at the Web page source sites;

FIG. 3 is an illustrative flowchart describing the setting up of the process of the present invention for video monitoring of moving groups of individuals in a delimited facility for facial recognition and common interests; and

FIG. 4 is a graphical illustration that attempts to conceptually show how the overlapping interests of the recognized individuals are used to determine common interests.

### DETAILED DESCRIPTION OF THE PREFERRED EMBODIMENT

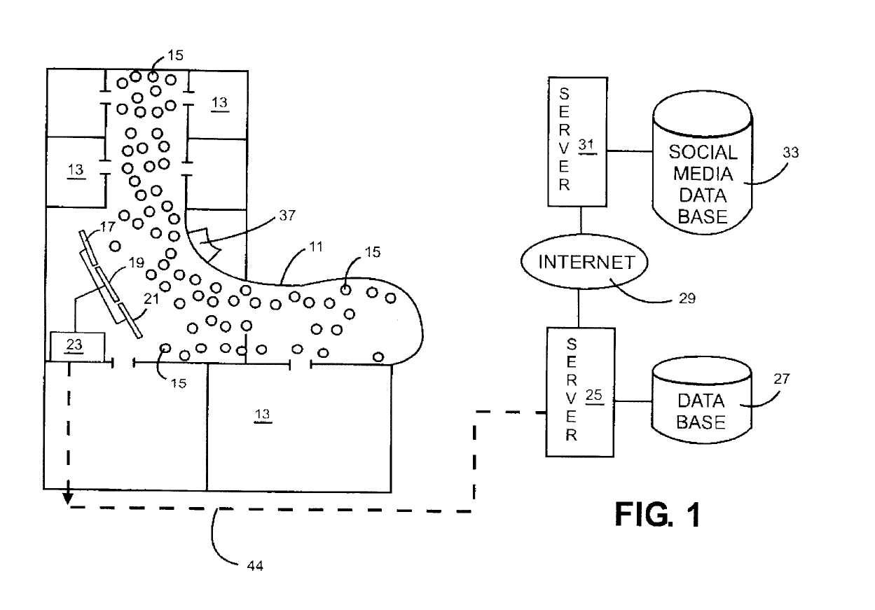

Referring to FIG. 1, there is shown a very generalized diagram of an illustrative shopping mall to demonstrate how the pedestrian traffic is monitored by a bank of video cameras and the supporting systems for accessing local databases according to the present invention. Video cameras may be installed in the entrance and exit areas of the mall and in portions of a mall 11. Cameras 17, 19 and 21 under the control of computer system 23 monitor the individual people 15 traffic in the corridors of the mall section between stores and businesses 13. Computer 23 is connected via connection 44 and server 25 to database 27 and via the Internet 29 and server 31 to a social media database 33, both databases 27 and 33 store facial recognition profiles in quantities sufficient for the databases to be considered as having profiles of masses of such individuals. Database 27 may store a somewhat more limited number of such profiles, e.g. profiles of recognized regular customers and return customers of the mall.

On the other hand, in the realm of social media, it is now common for members to agree to have their images stored in a database in return for provided social, communication and purchasing consumer privileges. With the phenomenal growth of such social media, databases may be expected to potentially store facial recognition profiles for millions of individuals. Accordingly, the databases are being defined herein as mass databases. While, for simplicity of illustration, only one social media database is shown, it should be understood that via the Internet, control computer 23 accesses facial recognition profiles from dozens of social media databases.

Through the combination of the local database 27 and the social media databases 33, the process will recognize the specific individuals through their stored facial recognition patterns, and then, as hereinafter described in greater detail, develop interests in common for groups of identified individuals. For example, for identified faces, the social network database 33 will be accessed for the stored user, i.e. identified individual's synopsis, likes and dislikes, the individual's recommendations and the individual's mobility. This data may be limited to sections of the mall or the whole mall.

The computer 23 programming will then screen the accessed information of a group of recognized individuals and screen, rank and weight the information to limit the resulting common interest of the group to the mall businesses. Information not so related will be filtered out. Based upon the resulting common interests, commercial information may conveniently be displayed, e.g. on a large corridor screen 37.

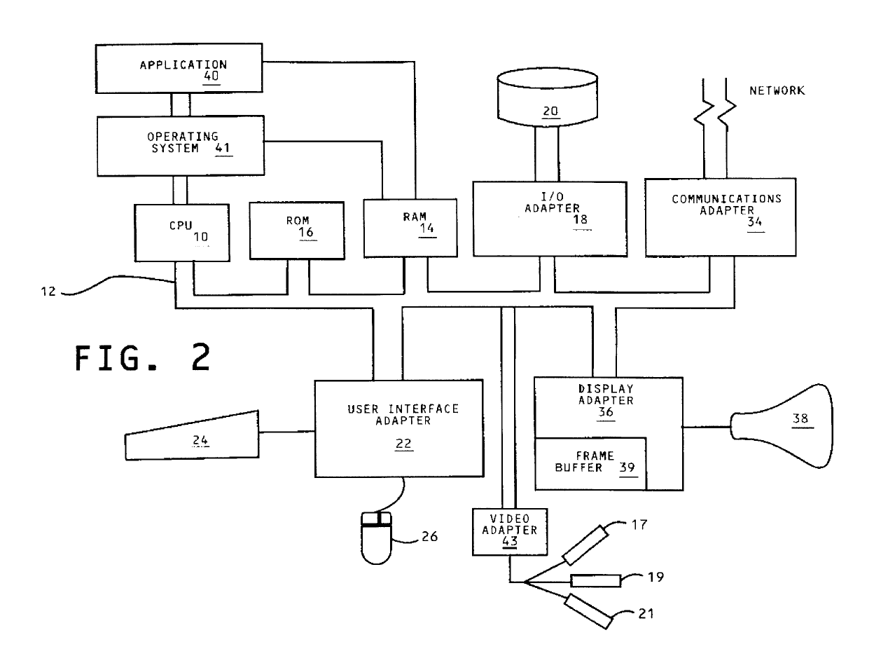

With respect to FIG. 2, there is shown an illustrative diagrammatic view of a data processing system including a central processing unit and network connections via a communications adapter that is capable of functioning as control computer 23 (FIG. 1) and servers 25 and 31.

A central processing unit (CPU) 10, such as one of the microprocessors, e.g. from System p series available from International Business Machines Corporation (IBM), is provided and interconnected to various other components by system bus 12. An operating system 41 runs on CPU 10, provides control and is used to coordinate the function of the various components of FIG. 2. Operating system 41 may be one of the commercially available operating systems. Application programs 40, such as the facial recognition and screening for common interests programs of this invention in computer system 23, are moved into and out of the main memory Random Access Memory (RAM) 14. These programming applications may be used to implement functions of the present invention. Read Only Memory (ROM) 16 includes the Basic Input/Output System (BIOS) that controls the basic computer functions of computer 23 or servers 25 and 31. RAM 14, storage adapter 18 and communications adapter 34 are also interconnected to system bus 12. Storage adapter 18 communicates with the disk storage device 20 that will provide database 27. Communications adapter 34 interconnects bus 12 with the outside Internet 29. I/O devices are also connected to system bus 12 via user interface adapter 22. Optionally, keyboard 24 and mouse 26 may be connected to bus 12 through user interface adapter 22. The mall display 37 is provided by display 38. Display buffer 39 connected through display adapter 36 to bus 12 supports display 38. The input from video cameras 17, 19 and 21 are provided to CPU 10 via video adapter 43 connected to system bus 12.

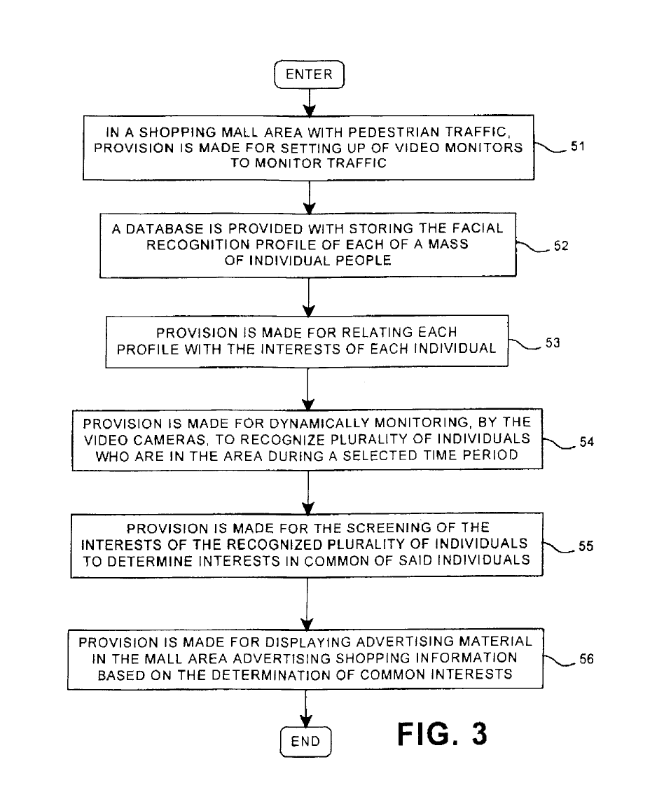

Referring now to FIG. 3, which is a general flowchart of an illustrative program set up to implement the present invention for video monitoring of moving groups of individuals in a delimited facility for facial recognition and common interests. Provision is made for setting up of video camera monitors to scan people traffic in a mall for facial recognition of individual people, step 51. A database is provided for storing the facial recognition profile of each of a mass of individual people, step 52. Provision is made for relating each profile with the interests of each recognized individual, step 53. Provision is made to enable dynamic monitoring by video cameras to recognize a plurality of individuals who are in a covered area during a selected time period, step 54. Provision is made for the screening of the interests of the recognized group of individuals to determine common interests, step 55. Provision is then made for displaying advertising material in the mall area presenting shopping and consumer information based on the determination of common interests, step 56.

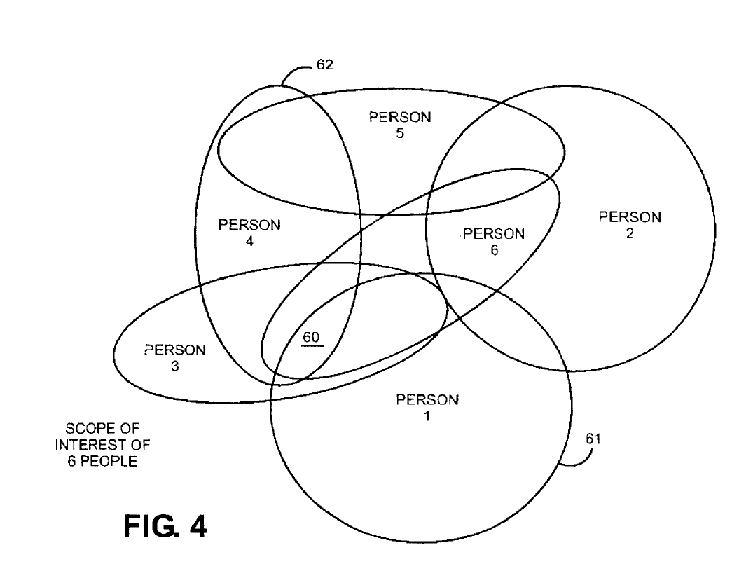

Referring now to FIG. 4, there is shown a graphic illustration overlapping closed curves representing how the maximum commonality of the interests of the recognized individuals may be determined. The interests of a group of six (6) recognized people, Person 1 through Person 6, are shown by the respective closed curve for each. It is noted that in some areas, e.g. areas 61 and 62 of curves for Persons 1 and 4, there is no overlap, indicating that the interests covered by these areas are not interests in common with other persons. On the other hand, area 60 represents a common interest to five (5) of the six (6) persons, i.e. all but person 2. Consequently, advertisements related to the interests represented in area 60 should be displayed.

It should be noted that in FIG. 4, six (6) individuals were selected for convenience of illustration. During peak business hours, a thousand persons may be in the mall. In determining commonality of interest, the common areas of interest may be ranked according to the number of people who share that interest. The determination of common interests may also be weighted; for example, according to the purchasing power of the particular people, e.g. shopping history at the mall.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

1. A computer controlled method for presenting information to groups of individuals dynamically moving into and out of a defined area comprising:
providing a database storing the facial recognition profile of each of a mass of individuals,
connecting each profile with interests of each individual;
dynamically video monitoring said defined area to recognize facial profiles of a plurality of individuals who are in the defined area during a time period;
screening the interests of said recognized plurality of individuals to determine interests in common of said plurality of individuals;
dynamically visualizing an area of interest of an individual as a circle surrounding each recognized individual;
monitoring said surrounding circles for maximum circle overlap densities; and
dynamically presenting information to said plurality of individuals within said desired area based upon said maximum dynamic circle overlap densities.

2. The method of claim 1, wherein the information is presented is visually displayed.

3. The method of claim 2, wherein the presented information is an advertisement related to businesses in said defined area.

4. The method of claim 3, wherein the defined area is a portion of a shopping mall.

5. The method of claim 3, wherein said interests of said individuals are derived from social media information provided by the individuals to said social media.

6. The method of claim 3, wherein the presented information is in the form of electronic entertainment.

7. The method of claim 4, wherein said screening for interests in common is weighted to include both numbers of individuals having selected interest, and the weight of the interests with respect to the interests of said businesses.

8. A computer controlled system for presenting information to groups of individuals dynamically moving into and out of a defined area comprising:
a processor; and
a computer memory holding computer program instructions which when executed by the processor perform the method comprising:
providing a database storing the facial recognition profile of each of a mass of individuals,
connecting each profile with interests of each individual;
dynamically video monitoring said defined area to recognize facial profiles of a plurality of individuals who are in the defined area during a time period;
screening the interests of said recognized plurality of individuals to determine interests in common of said plurality of individuals;
dynamically visualizing an area of interest of an individual as a circle surrounding each recognized individual;
monitoring said surrounding circles for maximum circle overlap densities; and
dynamically presenting information to said plurality of individuals within said desired area based upon said maximum dynamic circle overlap densities.

9. The system of claim 8, wherein the information is presented is visually displayed.

10. The system claim 9, wherein the presented information is an advertisement related to businesses in said defined area.

11. The system of claim 10, wherein the defined area is a portion of a shopping mall.

12. The system of claim 10, wherein said performed method derives the interests of said individuals from social media information provided by the individuals to said social media.

13. The system of claim 10, wherein the presented information is in the form of electronic entertainment.

14. The system of claim 11, wherein said performed method screens for interests in common by weighting the numbers of individuals having selected interest, with the weight of the interests with respect to the interests of said businesses.

15. A computer usable non-transitory storage medium having stored thereon a computer readable program for presenting information to groups of individuals dynamically moving into and out of a defined area, wherein the computer readable program when executed on a computer causes the computer to:
provide a database storing the facial recognition profile of each of a mass of individuals,
connect each profile with interests of each individual;
dynamically video monitor said defined area to recognize facial profiles of a plurality of individuals who are in the defined area during a time period;
screen the interests of said recognized plurality of individuals to determine interests in common of said plurality of individuals;
dynamically visualize an area of interest of an individual as a circle surrounding each recognized individual;
monitor said surrounding circles for maximum circle overlap densities; and
dynamically present information to said plurality of individuals within said defined area based upon said maximum dynamic circle overlap densities.

16. The computer usable storage medium of claim 15, wherein the information is presented is visually displayed.

17. The computer usable storage medium of claim 16, wherein the presented information is an advertisement related to businesses in said defined area.

18. The computer usable storage medium of claim 16, wherein the defined area is a portion of a shopping mall.

19. The computer usable storage medium of claim 16, wherein said program when executed causes the computer to derive said interests of said individuals from social media information provided by the individuals to said social media.

20. The computer usable storage medium of claim 17, wherein the presented information is in the form of electronic entertainment.

21. The computer usable storage medium of claim 13, wherein said program when executed causes the computer to screen for interests in common by weighting to include both numbers of individuals having selected interest, and the weight of the interests with respect to the interests of said businesses.
